(19) United States
(12) Patent Application Publication
(10) Pub. No.: US 2018/0118458 A1
(43) Pub. Date: May 3, 2018

(54) WASTE DISPOSAL DEVICE AND CASSETTE INTERFACE

(71) Applicant: Edgewell Personal Care Brands, LLC, Chesterfield, MO (US)

(72) Inventors: Alan Blatter, Hamden, CT (US); James Chasen, West Haven, CT (US); Sumanth Chakravarthy, Stamford, CT (US); Alexander Chenvainu, Mahwah, NJ (US); Joseph Fedora, South Acworth, NH (US); Condor Shen, New Haven, CT (US)

(21) Appl. No.: 15/643,822

(22) Filed: Jul. 7, 2017

Related U.S. Application Data
(60) Provisional application No. 62/359,724, filed on Jul. 8, 2016.

(51) Int. Cl. B65F 1/06; B65F 1/16

(52) U.S. Cl. CPC B65F 1/065; B65F 1/16; B65F 2240/164; B65F 2240/132; B65F 1/068

(57) ABSTRACT

An interface for a waste disposal device includes a cassette and a waste disposal device. Features of the interface reside on the cassette and on the waste disposal device. The interface permits connection of the cassette into the waste disposal device to assist with proper insertion and/or attachment of the cassette to the waste disposal device. In one embodiment, one or more latch features in the waste disposal device engage with one or more ramp features on the cassette body.

### CROSS-REFERENCE TO RELATED APPLICATIONS

This application claims priority to U.S. Provisional Patent Application Ser. No. 62/359,724, filed Jul. 8, 2016, the entirety of which is incorporated herein.

### BACKGROUND OF THE INVENTION

### 1. Technical Field

The present disclosure relates to an apparatus for packaging disposable material or objects into a tubular flexible plastic film material in general, and to devices that utilize cassettes for providing the tubular flexible plastic film material in particular.

### 2. Background Information

Waste disposal devices that include a replaceable liner dispensing cassette are commonly used to throw away odorous waste, such as diapers and litter. In such waste disposal devices, the liner dispensing cassettes are typically positioned near the top of the device and have a length of tubular liner and/or dispense a tubular liner projecting into an internal space of the waste-disposal device. New cassettes are loaded into the waste-disposal device and once the liner has been used, the now spent cassette is removed from the waste-disposal device. The manner in which a cassette is loaded and removed is not always easily determined in prior art devices, and can cause user frustration. Moreover, it is not always apparent whether the cassette is properly loaded within prior art devices. It would be desirable to provide a waste-disposal device that facilitated loading and unloading of cassettes.

### SUMMARY

According to an aspect of the present disclosure, a waste disposal device cassette interface is provided. The interface includes a cassette seat and a latch mechanism. The cassette seat has at least one wall portion and is configured to receive at least a portion of a liner cassette. The latch mechanism is configured to retain the cassette within the cassette seat.

According to another aspect of the present disclosure a waste disposal device cassette interface is provided that includes a cassette seat, at least one forward latch mechanism, and at least one aft latch mechanism. The cassette seat is configured to receive at least a portion of a liner cassette. The at least one forward latch mechanism is selectively configurable in an engaged position and a disengaged position. In the engaged position, the forward latch mechanism is positioned to retain the cassette within the cassette seat. The at least one aft latch mechanism is normally biased in an engaged position. In the engaged position, the aft latch mechanism is positioned to retain the cassette within the cassette seat.

According to another aspect of the present disclosure, a waste disposal device is provided that includes a housing and a cassette interface. The cassette interface is disposed at least partially within the housing. The cassette interface has at least one wall portion and is configured to receive at least a portion of a liner cassette. The cassette interface further comprises a latch mechanism that is configured to retain the cassette within the cassette seat. The latch mechanism is releasable to allow the cassette to be removed and replaced. In some embodiments, the release of the latch mechanism allows the cassette to be at least partially ejected from the waste disposal device, such that the cassette is more easily grasped by the user and removed from the waste disposal device.

According to another aspect of the present disclosure, a waste disposal device is provided that includes a liner cassette, a housing, and a cassette interface. The cassette has an outer perimeter. The cassette has an inner perimeter defining a central opening for disposal of waste. The cassette has a length of liner film that is either attached to cassette (i.e. a single-use configuration) and/or is stored within a storage volume of the cassette. The cassette, in certain embodiments, has an outer wall defined by the outer perimeter and an inner wall defined by the inner perimeter. The cassette has a bottom surface and an upper surface. One surface (i.e. top or bottom) can be a lid. The liner cassette has at least one latch feature. In some embodiments, the latch feature is located on the outer perimeter, and in some embodiments, on the outer wall. In some embodiments, the latch feature is located proximal the bottom portion of the outer perimeter, and in some embodiments, towards the bottom portion of the outer wall. In some embodiments, the latch feature is located proximal to the bottom surface or on the bottom surface. The cassette interface is disposed at least partially within the housing. The cassette interface includes a cassette seat configured to receive at least a portion of the liner cassette, and a first latch mechanism configured to cooperate with the cassette latch feature to retain the cassette within the cassette seat.

In some embodiments, the cassette latch feature has a ramp surface. The ramp surface interacts with the first latch mechanism such that as the cassette is inserted into the waste disposal device, the ramp surface engages and rides along and/or depresses the first latch mechanism (i.e. which is a biased mechanism), ultimately passing the first latch mechanism. The first ramp surface can coincide with a lower surface of the latch feature. The first latch mechanism thereafter releases from a biased or compressed state and returns to a rest (i.e. unbiased or uncompressed) state, securing the cassette within the waste disposal device. In some embodiments, the cassette is secured adjacent the cassette seat. The ramp surface is sloped upwardly from the outer perimeter (or outer wall).

In some embodiments, the cassette latch feature has a second ramp surface. The second ramp surface interacts with the first latch mechanism such the cassette can be more easily released from the waste disposal device (i.e. when the liner film is exhausted and the empty cassette needs to be replaced). The second ramp surface can coincide with an upper surface of the latch feature. The second ramp surface can be adjacent the first ramp surface. The second ramp surface can be separated from the first ramp surface, by a gap, by a plateaued surface, and/or other physical/structural means.

Ramp surfaces can be linear, arcuate, have steps, and/or combinations thereof. The first ramp surface and second ramp surface can have the same slope, or can have different slopes. In some embodiments, having different slopes is preferable, as the second ramp may require a slope that approaches and/or is parallel to the Y-X plane to ensure the cassette is secured and/or firmly seated in the waste disposal device. One or more ramp surfaces may be located at any given location on the outer perimeter of the cassette. In some embodiments, the cassette has ramp surfaces that are symmetric about an axis or plane. In other embodiments, the cassette has ramp surfaces that are asymmetric about an axis or plane. Depending on the geometry, shape, construction and/or configuration of the cassette and the ramps, having ramps in a particular configuration (i.e. with or without symmetry) is preferable. In embodiments where the cassette has a unique geometry such as an ovoid, triangle, rhomboid, polygon, or derivative thereof, the ramp surfaces (or other latch feature) may be asymmetrically and/or symmetrically positioned on the cassette.

In some embodiments, the cassette has at least one latch mechanism. In other embodiments, the cassette has at least two latch mechanisms. In these embodiments, the two latch mechanisms can be on opposite ends of the cassette (i.e. one forward and one aft) or the two latch mechanisms can be on a similar portion of the cassette (i.e. both in the forward portion of the cassette). In further embodiments, the cassette has at least three latch mechanisms. These latch mechanisms can assist in securing the cassette to the waste disposal device where the cassette has an atypical geometry and thus requires multiple latch mechanisms at varying locations on the cassette.

In other embodiments, the cassette latch mechanism is at least one L shaped member, or a member having two portions that extend in two different planes (and optionally, along two different axes). In these embodiments, the cassette latch mechanism connects to the first latch feature via rotation of the cassette about a forward portion of the outer perimeter of the cassette. The terms “cassette latch feature” and “cassette latch mechanism” are used interchangeably throughout the present disclosure. This rotation can be described as a “toe-in” movement/connection. The L shaped member is positioned such that the lower portion of the L points upward towards an upper surface of the cassette. The L shaped member is positioned on the outer perimeter of the cassette and in some embodiments, the outer wall of the cassette. The L shaped member is positioned proximal the bottom surface of the cassette. The cassette latch mechanism, in some embodiments, has two L shaped members, or a member having two portions that extend in two different planes (and optionally, along two different axes). In these embodiments, the first latch mechanism includes an aperture sized to receive at least the lower portion of the L shaped member. The aperture is sized such that the height of the orifice is less than the length of the lower portion of the L shaped member. The depth of the aperture permits the L shaped member to rotate inside the aperture in order to achieve a state where the cassette is secured to the waste disposal device and the lower portion of the L shaped member is at least partially secured within the aperture. In some embodiments, the first latch mechanism has two apertures, where each aperture receives a different L shaped member. In further embodiments, the first latch mechanism also assists with the at least partial ejection of the cassette from the waste disposal device.

The cassette interface according the present disclosure provides further advantages in that it ensures the cassette is properly secured to the waste disposal device such that the lid of the waste disposal device, typically situated above the opening of the wasted disposal device and thus above the cassette, is able to properly close after waste is inserted into the waste disposal device. In other words, the cassette is secured to the waste disposal device such that a portion of the cassette isn't outward of the opening and interfering with the ability of the lid to completely close.

Furthermore, the cassette, when secured to the waste disposal device, is easier for the user to prepare for use with a single hand. For instance, once the cassette is secured to the waste disposal device, a user can adjust the liner film attached to the cassette (and/or within the cassette body) without requiring a second hand to hold the cassette in a stationary position.

Yet further still, the cassette is secured to the waste disposal device about the outer, inner or bottom portion of the cassette such that the manipulating the liner film is not limited by a securing feature above the cassette (i.e. such as an inner lid or other retention structure that secures the cassette into the waste disposal device at a location above or adjacent the upper surface of the cassette).

### BRIEF DESCRIPTION OF THE DRAWINGS

FIG. 1 is a perspective view of a waste disposal device embodiment.

FIG. 2 is a perspective view of a liner cassette embodiment.

FIG. 3 is a perspective view of a cassette interface portion of a waste disposal device.

FIG. 4 is a sectioned perspective view of a cassette interface portion of a waste disposal device.

FIG. 5 is a sectioned side planar view of a cassette interface portion of a waste disposal device.

FIG. 6 is an enlarged portion of the cassette interface shown in FIG. 5.

FIG. 7 is a diagrammatic view of a latch member of a front latch mechanism embodiment.

FIG. 8 is a perspective view of a portion of a cassette interface with a cassette mounted thereon.

FIG. 9 is a perspective view of a portion of a cassette interface.

FIG. 10 is a diagrammatic view of a latch member of an aft latch mechanism embodiment.

FIG. 11 is a diagrammatic view of a cassette biasing mechanism.

FIG. 12 is a partial diagrammatic view of a cassette embodiment.

FIG. 13 is a partial diagrammatic view of a cassette interface embodiment with a cassette mounted thereon.

FIG. 14 is a partial diagrammatic view of a cassette interface embodiment with a cassette.

FIG. 15 is a diagrammatic view of a cassette interface embodiment with a cassette, with a partial break away to illustrate elements.

FIG. 16 is a diagrammatic detailed view of the cassette interface embodiment as shown in FIG. 15.

FIG. 17a is a diagrammatic sectional view of a cassette latch feature according to the present disclosure.

FIG. 17b is a diagrammatic sectional view of a cassette latch feature according to the present disclosure.

FIG. 17c is a diagrammatic sectional view of a cassette latch feature according to the present disclosure.

FIG. 18 is a diagrammatic perspective view of a waste disposal device according to the present disclosure having a front loaded cassette.

FIG. 19 is a diagrammatic partial perspective view of a waste disposal device according to the present disclosure having a front loaded cassette.

FIG. 20 is a diagrammatic partial perspective view of a waste disposal device according to the present disclosure having a front loaded cassette.

FIG. 21 is a sectional perspective view of a portion of a cassette interface embodiment.

FIG. 22 is an exploded perspective partial view of a portion of a cassette interface embodiment.

FIG. 23 is a bottom perspective view of a cassette embodiment.

FIG. 24 is an exploded perspective view of a cassette interface embodiment.

FIG. 25 is a sectional side view of a cassette interface embodiment.

FIG. 26 is an exploded diagrammatic perspective view of a cassette interface embodiment.

FIG. 27 is an exploded diagrammatic perspective view of a cassette interface embodiment, with a top panel removed.

FIG. 28 is a partial perspective view of a cassette interface embodiment.

FIG. 29 is an enlarged view of a portion of the cassette interface embodiment shown in FIG. 28.

FIG. 30 is a top perspective view of a cassette embodiment.

FIG. 31 is a perspective view of a cassette interface embodiment.

FIG. 32 is a diagrammatic view of a latch mechanism embodiment.

FIG. 33 is a diagrammatic view of a latch mechanism embodiment.

FIG. 34 is an exploded diagrammatic perspective view of a cassette interface embodiment.

### DETAILED DESCRIPTION

The present disclosure is directed to a waste disposal device 20 that includes a cassette 44 for dispensing a liner material, to a waste disposal device 20 that includes a cassette interface 34 operable to mount and to retain the cassette 44 within the waste disposal device 20, and to a cassette seat 36 of a waste disposal device 20. The terms “cassette” and “liner cassette” are used interchangeably throughout the present disclosure. The terms “liner”, “liner material”, “film”, “film material”, “liner film” and other similar terms or variants are used interchangeable throughout the present disclosure. The waste disposal device 20 is a receptacle for waste products (e.g., diapers, litter, feminine hygiene products, etc.). The liner material provides a bag like structure for receiving the waste products.

As will be evident from the detailed description of embodiments below, the present disclosure provides a waste disposal device 20 having a cassette interface 34 that enables a cassette 44 to be maintained within the waste disposal device 20 by a means other than just gravity, and/or enables a cassette 44 to be at least partially ejected from the cassette interface 34. Indeed, the cassette interface 34 is believed to be new and useful by itself as well; e.g., as a component that could be independently manufactured, or used without a waste disposal device 20. Also as will be evident from the description below, the present disclosure provides a user with a tactile indication (and in some instances an audible indication as well) that the cassette 44 is properly seated and maintained within the cassette interface 34, and therefore within the waste disposal device 20.

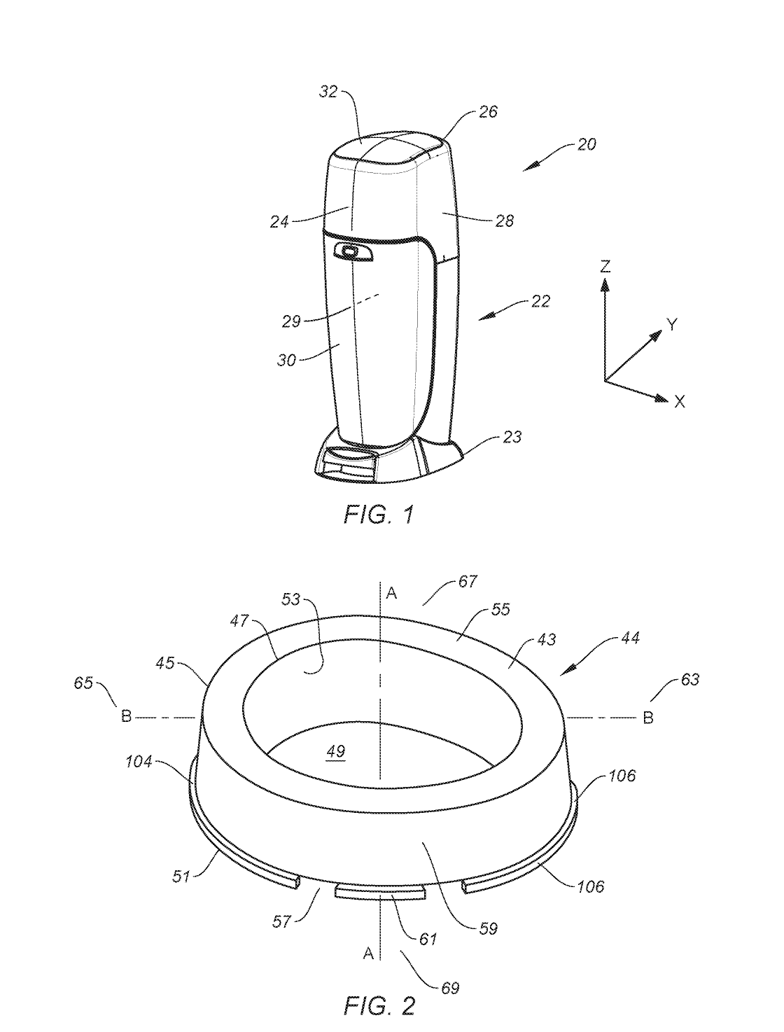

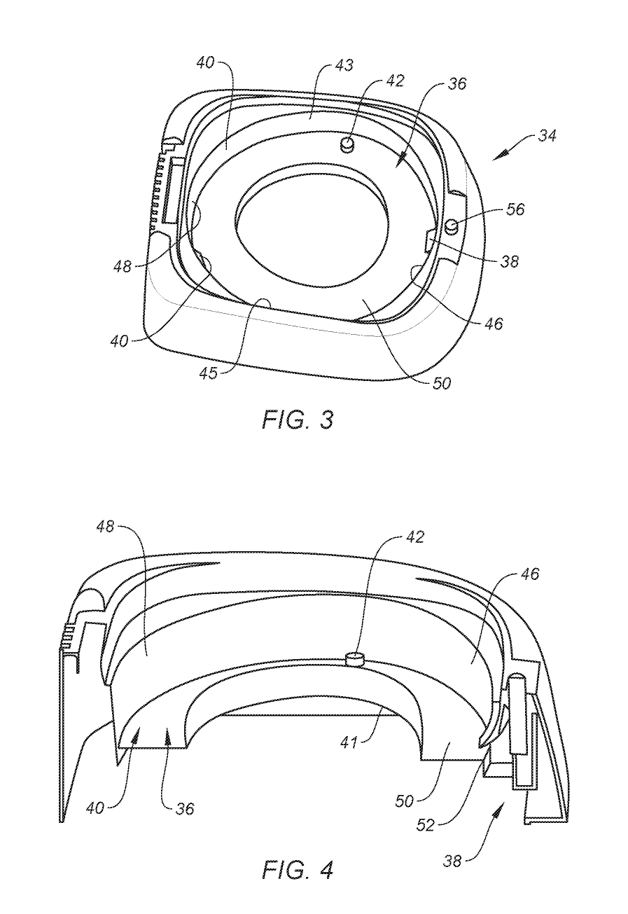

An example of a waste disposal device and a liner cassette are shown in FIGS. 1 and 2. The waste disposal device 20 shown in FIG. 1 a plurality of independent housing portions assembled to form a housing 22 of the waste disposal device 20; e.g., a base portion 23 attached to an upper portion. Alternatively, the waste disposal device 20 may have a unitary housing 22 structure. The waste disposal device 20 shown in FIG. 1 is shown having a housing 22 with a generally rectangular cross-sectional shape, but the present waste disposal device 20 is not limited to any particular cross-sectional shape; e.g., circular, elliptical, triangular, square, etc. Hence, in some embodiments the waste disposal device 20 may be described as having a forward wall portion 24, an aft wall portion 26, and a pair of side wall portions 28 extending between the forward and aft wall portions (24 and 26 respectively). Waste disposal devices 20 having a cross-sectional shape other than generally rectangular may have other wall portions and/or fewer wall portions. The wall portions may be a continuous piece and/or separate pieces. The waste disposal device 20 includes an interior space 29 for receiving a length of the liner material; e.g., a length of liner material configured to receive and contain waste products. The waste disposal device 20 shown in FIG. 1 includes a pivoting front panel 30 that opens to provide access to the interior space. The waste disposal device 20 further includes a lid 32 and a cassette interface 34 (e.g., see FIGS. 3 and 4) both of which are disposed above the interior space 29. The exemplary waste disposal device 20 shown in FIG. 1 includes a lid 32 that is operated between a closed position and an open position by a pedal disposed on the front bottom of the waste disposal device 20. The present disclosure is not limited to this embodiment, however; e.g., a lid 32 may be configured to be opened or closed directly by hand. To facilitate the description herein, the waste disposal device 20 may be described in terms of orthogonal axes; e.g., the device may be described as having a length (Z-axis) that extends in a direction between the base and the lid 32 (e.g., a vertical direction when the waste disposal device 20 is standing in its intended manner), a width (X-axis) that extends in a direction between the side wall portions, and a depth (Y-axis) that extends in a direction between the forward and aft wall portions (24 and 26, respectively).

The cassette 44 has a body 43 having an outer perimeter 45 and an inner perimeter 47. The inner perimeter 47 defines a central opening 49 through which waste can be deposited into the liner film. In some embodiments, the outer perimeter 45 defines an outer wall 51. In some embodiments, the inner perimeter 47 defines an inner wall 53. As such, the cassette 44 has one or more surfaces including, for instance, the outer wall 51 and/or inner wall 53, and/or other surfaces described herein. The cassette 44 has an upper surface 55 and a lower surface 57. The cassette 44 also has one or more regions and/or portions, as described herein. The cassette 44 has an upper portion 59 and a bottom portion 61. The cassette 44 has a forward region 63 and an aft region 65 as described with reference to line A-A. The cassette 44 has a first side region 67 and a second side region 69, as described with reference to line B-B. The cassette 44 can further be described to have regions (i.e. front first side, front second side, aft first side, aft second side, etc.), as demonstrated by reference lines A-A and B-B. The cassette 44, as exemplified in this paragraph and throughout the present disclosure, can be defined in regions with respect to a perimeter, a surface, a wall, etc. The cassette 44 can have various shapes and geometries, such that any perimeter, wall, surface or combination thereof can lead to an arcuate or polygonal shape.

At least a portion of a cassette interface 34 is enclosed within the device when the lid 32 is disposed in a closed position. In some embodiments, the cassette 44 is minimally, flush with the exterior of the waste disposal device, 20. In many embodiments, the cassette 44 is completely contained within the waste disposal device 20. The cassette interface 34 according to the present disclosure may assume a number of different embodiments.

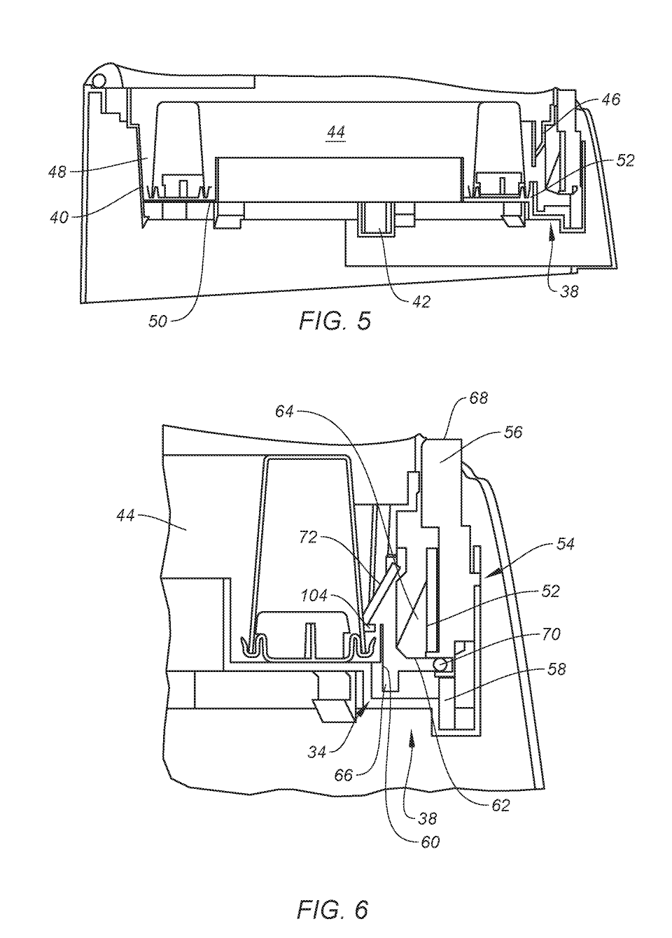

In a first embodiment shown in FIGS. 3-10, the cassette interface 34 includes a cassette seat 36, at least one front latch mechanism 38, at least one aft latch mechanism 40, and may include a cassette biasing mechanism 42. The at least one front latch mechanism 38 and the at least one aft latch mechanism 40 can be described generally as a latch mechanism, and optionally, in some embodiments, are similar and/or utilize at least some of the same components. Alternatively, (or perhaps depending on the waste disposal device configuration), the at least one front latch mechanism 38 and/or the at least one aft latch mechanism 40 are positioned to either side, or, in other embodiments, are a combination of front and to a first side and/or aft and to a second side, etc. . . . . Front latch mechanism 38 and aft latch mechanism 40 each have at least one latch member 52. For clarity, latch mechanisms include latch members and optionally other components. The cassette seat 36 is configured to receive at least a portion of the cassette 44 (e.g., see FIG. 5) and may include at least a front wall portion 46 (e.g., that extends substantially lengthwise) and an aft wall portion 48 (e.g., that extends substantially lengthwise). The cassette seat 36 can be any suitable shape to mate the bottom portion 61 and/or bottom wall 57 of the cassette 44. For instance, to the extent the cassette 44 has a flat, stepped, arcuate, undulating or combinations thereof bottom surface, the cassette seat 36 would facilitate at least partial engagement with said cassette 44 (i.e. and thus be flat, stepped, arcuate, undulating, combinations thereof, etc.). In some embodiments, the cassette seat 36 matches at least 50% of the bottom portion 61 and/or bottom wall 57. In some embodiments, the cassette seat 36 matches at least 75% of the bottom portion 61 and/or bottom wall 57. In some embodiments, the cassette seat 36 completely engages the cassette 44 bottom portion 61 and/or bottom wall 57 such that the cassette seat 36 mates with substantially all of the bottom portion 61 and/or bottom wall 57. The cassette interface 34 may further include a base wall portion 50 as well, where the base wall portion 50 extends so as to be vertically below the liner cassette 44 when a liner cassette 44 is present within the device 20. FIG. 3 shows an embodiment of a cassette seat 36 that includes a front wall portion 46 and an aft wall portion 48 connected to one another (e.g., continuously extending around the perimeter of the cassette seat 36), a first side wall portion 43 and a second side wall portion 45, and a base wall portion 50. The present disclosure is not limited to this particular embodiment and may have, for instance, wall portions that are discontinuous.

The front latch mechanism 38 includes at least one latch member 52 and a latch biasing mechanism 54. The latch biasing mechanism 54 includes a button 56 configured to actuate the latch member 52. The button 56 is normally disposed in a first position (e.g., extended, as shown in FIG. 6) and selectively translatable to a second position (e.g., depressed). In the second position, the latch biasing mechanism 54 maintains the latch member 52 in a disengaged position. In the disengaged position, the latch member 52 does not engage a cassette 44 disposed within the cassette seat 36 and therefore does not retain the cassette 44 within the cassette seat 36. In the normal first position, the latch biasing mechanism 54 maintains the latch member 52 in an engaged position. In the engaged position, the latch member 52 may be engaged with a cassette 44 disposed within the cassette seat 36 (if present) and therefore assists in maintaining the cassette 44 within the cassette seat 36. The ability of the present latch mechanisms 38, 40 (as described above and below) to secure the cassette 44 avoids the user having to hold the cassette 44 in place; e.g., during the process of tying off a full liner prior to removal, etc.

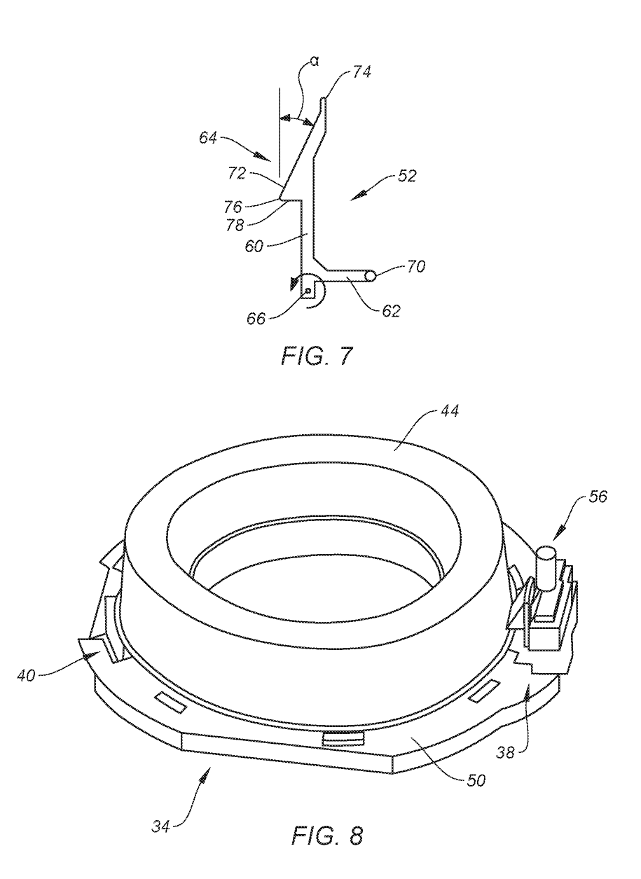

The front latch mechanism 38 as described above, can assume a variety of different configurations. To illustrate, non-limiting examples of front latch mechanisms 38 are provided hereinafter. Referring to FIGS. 4-9, in a first configuration the front latch mechanism 38 includes a substantially L-shaped latch member 52, button 56, and a spring 58. The substantially L-shaped latch member 52 has a first leg 60, a second leg 62, and a head portion 64. The latch member 52 is pivotally attached to the cassette interface 34 adjacent (or at) the point of intersection between the two legs 60, 62. The latch member 52 shown in FIGS. 6 and 7, for example, has a pivot axis 66 extending outward from the figure. As shown in FIG. 6, the pivot axis 66 is disposed below the point of intersection between the two legs 60, 62. Other locations for the pivot axis 66 are possible and demonstrated throughout the present disclosure such that a latch mechanism such as the front latch mechanism 38 is able to move between an engaged position and a disengaged position. The head portion 64 (described in more detail below) is attached to the first leg 60 of the member. The second leg 62 is configured for engagement with the button 56 as will be described below.

The button 56 may be configured and mounted (e.g., to the cassette interface 34) for linear translation (e.g., vertical). In some embodiments, the button 56 is configured and mounted for linear translation along both the vertical and horizontal axes (i.e. where the button is disposed on a portion of the waste disposal device 20 other than where the latch member 52 is). In such embodiments, there may be a linkage or a series of linkages between the user contact end 68 and the latch member contact element 70. The button 56 includes a user contact end 68 and latch member contact element 70. The latch member contact element 70 is configured for engagement with the second leg 62 of the latch member 52; e.g., the button member contact element 70 and the front latch second leg 62 have mating features that allow relative pivotal movement. In the embodiment shown in FIGS. 6 and 7, for example, the latch second leg 62 has a cylindrical member that is received in a slot of the button member contact member 70. As the button 56 is translated, the cylindrical member rotates within the slot, but remains within the slot 71. Cylindrical member can be other shapes such as curved, arcuate, faceted, etc. . . . such that the appropriate degree of freedom is provided to enable movement of the latch mechanism as per the geometry of the slot 71.

The button 56 is positioned to improve the user experience with the waste disposal device 20. The button 56, as shown in FIG. 3, is located proximal the forward wall portion 24 of the waste disposal device 20 (i.e. opposite the aft wall portion 26 that would typically be placed against a wall). In other embodiments, the button 56 is located to a side of the waste disposal device 20 such that the button 56 is conveniently located (i.e. proximal to where the user most frequently interacts with the waste disposal device 20) but located such that it avoids inadvertent contact while disposing of waste (which is typically done near the front wall portion 24). In other embodiments, the button 56 is located proximal the aft wall portion 26 to avoid inadvertent contact and also avoid grabbing attention and/or contact from a small child. In some embodiments, as exemplified in FIG. 3, button 56 is covered by the lid 32 (albeit the lid 32 does not interfere with the button 56) such that the button 56 is not accessible except for when an empty cassette 44 needs to be replaced (i.e. when the lid 32 is up).

The spring 58 acts between a fixed surface (e.g., the cassette interface 34) and the button 56, normally biasing the button 56 upwardly. In the embodiment shown in FIG. 6, the spring 58 is shown as a resilient band (e.g., oval shaped) configured to elastically deflect; e.g., when the spring 58 is deflected, the minor axis of the oval is decreased. The present disclosure is not limited to this type of spring 58; e.g., one or more coil springs, flat springs, tension springs, or the like, may be used alternatively.

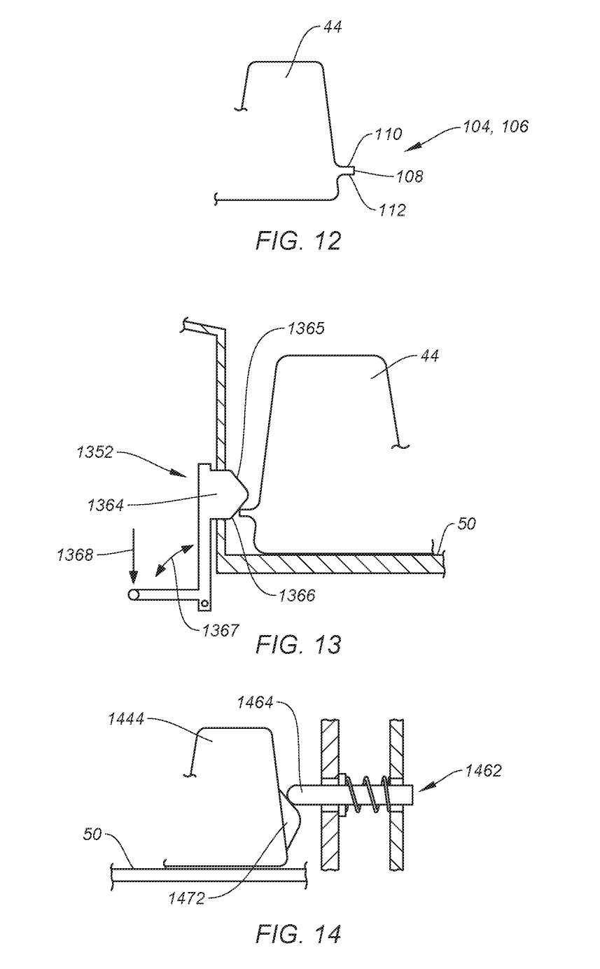

The latch member head portion 64 is configured to mate with a latch feature 104 (e.g., see FIGS. 2 and 12) extending outwardly from the cassette 44, to permit the cassette 44 to be inserted into the cassette seat 36 of the cassette interface 34, and to assist in maintaining the cassette 44 within the cassette seat 36 once the cassette 44 is inserted. For example, in the embodiment shown in FIGS. 6 and 7, the head portion 64 has an exposed ramp surface 72 (disposed at an angle “α” relative to a gravitational vertical line when the device 20 is standing in its intended orientation) extending substantially between a top edge 74 and a bottom edge 76, and a catch surface 78 extending from the bottom edge 76 (in a substantially horizontal direction). Angle α is generally between 0 and 90 degrees. In some embodiments, Angle α is between about 5 and 85 degrees, and more preferably between about 10 degrees and about 60 degrees, such that it is neither parallel nor perpendicular with the x-y plane and thus engages a cassette latch mechanism(s) 104 more easily. The embodiment shown in FIGS. 6 and 7 illustrates an example of a latch member head portion 64 that can be used within the front latch mechanism 38 and the present disclosure is not limited thereto.

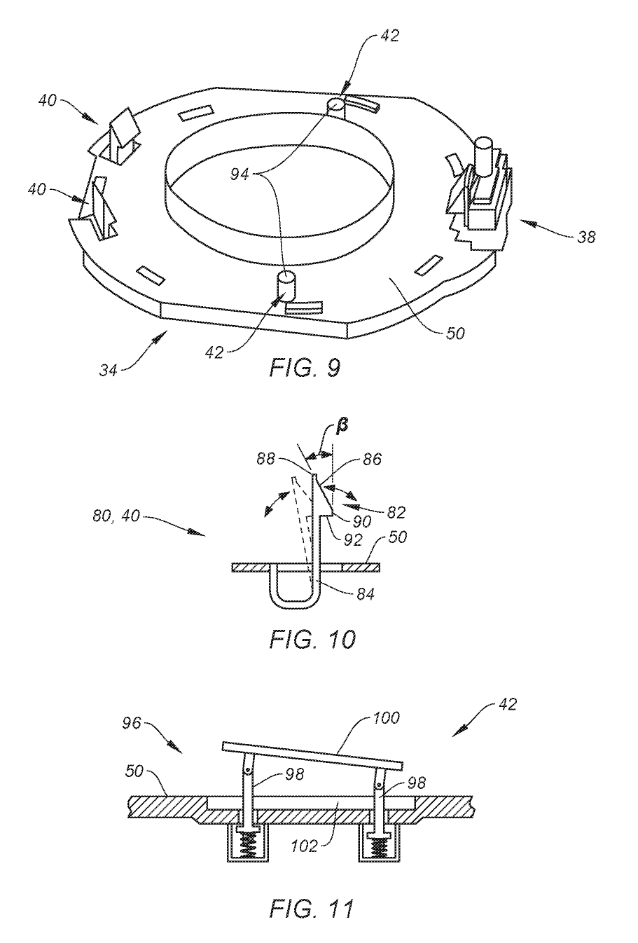

Referring to FIGS. 3, 4, and 8-10, the aft latch mechanism 40 includes at least one latch member 52 configured to be normally biased in an engaged position and operable to be elastically deflected away from the engaged position. The non-limiting embodiment shown in FIGS. 3, 4, 8, and 9 includes two aft latch mechanisms 40. The latch member 52 includes a head portion 82 mounted on a cantilevered stem 80. The head portion 82 is configured to mate with a latch feature 106 (e.g., see FIGS. 2 and 12) disposed on the cassette 44, to permit the cassette 44 to be inserted into the cassette seat 36 of the cassette interface 34, and to maintain the cassette 44 within the cassette seat 36 once the cassette 44 is inserted. For example, in the embodiment shown in FIGS. 9 and 10, the head portion 82 has an exposed ramp surface 86 (disposed at an angle “β” relative to a gravitational vertical line when the device 20 is standing in its intended orientation) extending substantially between a top edge 88 and a bottom edge 90, and a catch surface 92 extending from the bottom edge 80 (in a substantially horizontal direction). In some embodiments, either of catch surfaces 78, 92 are angled upwardly rather than being substantially flat. Catch surfaces 78, 92 are angled upwardly towards leg 60 in embodiments where a greater latch force is useful and/or angled away from leg 60 where a lesser latch force is useful. In some embodiments, catch surfaces 78 and/or 92 have a curved surface. Angle β is generally between 0 and 90 degrees. In some embodiments, Angle β is between about 5 and 85 degrees, and more preferably between about 10 degrees and about 60 degrees, such that it is neither parallel nor perpendicular with the x-y plane and thus engages a cassette latch mechanism(s) 106 more easily. In some embodiments, angles α and β are similar. In other embodiments, angles α and β are not equal. The embodiment shown in FIGS. 3, 4, and 8-10 illustrates an example of a latch member head portion 82 that can be used within the aft latch mechanism 40 and the present disclosure is not limited thereto.

The cassette biasing mechanism 42 is operable to bias a cassette 44 disposed in the cassette seat 36 of the cassette interface 34 upwardly (i.e., vertically upwardly). Biasing the cassette 44 upwardly, facilitates removal of the cassette 44 from the interface 34 (e.g., may at least partially eject the cassette 44 when the respective latch mechanisms are disengaged) and may maintain the cassette 44 engaged with one or both of latch mechanisms 38, 40.

The cassette biasing mechanism 42 may assume a variety of different embodiments. For example, in a first embodiment shown in FIGS. 3-5 and 9, the cassette biasing mechanism 42 includes at least one spring biased button 94 that extends up though a base wall portion 50 of the cassette seat 36. When a cassette 44 is loaded into the cassette interface 34, the spring biased button(s) 94 is depressed some amount and is biased against the cassette 44 to provide a vertical direction force acting against the cassette 44. In a second embodiment (diagrammatically shown in FIG. 11), the cassette biasing mechanism 42 includes at least one push bar assembly 96 in communication with a base wall portion 50 of the cassette seat 36. In this embodiment, the push bar assembly 96 includes at least two spring biased stems 98 connected to one another by a bar 100. Push bar assemblies 96 can be shaped and configured to include at least one spring biased stems 98. Other embodiments include at least one push bar assembly 96, and in other embodiments, at least two push bar assemblies 96, or in other embodiments, at least three push bar assemblies 96. The spring biased stems 98 may be fixedly attached to the bar 100, or may be pivotally attached to the bar 100. Pivotal attachment between the bar 100 and the stems 98 allows the relative orientation of the bar 100 and the base wall portion 50 of the cassette seat 36 to vary during the travel of the push bar assembly 96; e.g., the orientation of the bar 100 and the base wall portion 50 may be parallel or skewed relative to one another. When a cassette 44 is loaded into the cassette interface 34, the push bar assembly(s) 96 is depressed some amount and is biased against the cassette 44 to provide a vertical direction force acting against the cassette 44. The base wall portion 50 of the cassette seat 36 may include a channel 102 for receiving the bar 100 when the push bar assembly 96 is completely depressed, or the bar 100 may be disposed above the base wall portion 50 when the push bar assembly 96 is completely depressed. The above described examples of a cassette biasing mechanism 42 are provided as examples, and the present cassette biasing mechanism 42 is not limited thereto.

Referring to FIGS. 2, 6, and 8 the cassette interface 34 embodiments described above may be utilized with a variety of different types of cassettes 44 and are not, therefore, limited to any particular type of cassette 44. As indicated above, the cassette 44 (regardless of its specific configuration) includes at least one front latch feature 104 (the specific number of front latch features 104 may correspond to the number of front latch mechanisms 38) and at least one aft latch feature 106 (the specific number of aft latch features 106 may correspond to the number of aft latch mechanisms 40). The at least one front latch feature 104 and the at least one aft latch feature 106 can be described generally as a latch feature, and optionally, in some embodiments, are similar and/or utilize at least some of the same components. In some embodiments, there are at least three latch features (i.e. 104 and/or 106). In other embodiments, there are at least four latch features (104 and/or 106). For cassettes 44 having a geometry with a single, perhaps continuous, perimeter such as a circle, or cassettes 44 having multiple sides, as with polygons such as triangles, rhomboids, pentagons, hexagons, octagons and decagons, front latch feature(s) 104 and aft latch feature(s) 106 may be indistinguishable. In some polygonal embodiments, there may be a latch feature on each side. In some embodiments, the latch features are positioned such that they are located about the cassette 44 in a symmetric fashion, that is, symmetric with respect to the lengthwise axis (i.e. z-axis) or widthwise (i.e. x-axis) of the cassette 44. In some embodiments, the latch features are positioned such that they are located about the cassette 44 in an asymmetric fashion, that is, asymmetric with respect to the lengthwise axis (i.e. z-axis) or widthwise (i.e. x-axis) of the cassette 44. In further embodiments, the latch features are positioned at varying heights (or depths) along the y-axis of the cassette 44.

The front latch feature(s) 104 is(are) configured to mate with the head portion 64 of the latch member 52 of the respective front latch mechanism 38, and the aft latch feature(s) 106 is(are) configured to mate with the head portion 82 of the respective latch member 52 of the aft latch mechanism 40. For example, FIG. 12 diagrammatically shows a latch feature 104, 106 that extends outwardly from a surface of the cassette 44, positioned to align with the respective front or back latch mechanism 38, 40 when the cassette 44 is inserted into the cassette seat 36 of the cassette interface 34. The latch feature 104, 106 embodiment shown in FIG. 12 includes an outer edge 108 extending between an upper surface 110 and a lower surface 112. The present disclosure is not limited to the latch feature embodiment shown in FIG. 12; e.g., the latch feature 104, 106 may assume a variety of geometric configuration such as triangular, a curved surface, etc.

As will be described below, in some embodiments of the present disclosure when a cassette 44 is disposed within the cassette seat 36 of the cassette interface 34, the upper surface 110 of each latch feature 104, 106 is engaged with the catch surface 78, 92 of the respective latch mechanism 38, 40. Similarly in the aforesaid embodiments, when a cassette 44 is being inserted into the cassette seat 36 of the cassette interface 34, the lower surface 112 of each latch feature 104, 106 engages the ramp surface 72, 86 of the respective latch mechanism 38, 40. The embodiment shown in FIG. 12 shows the upper surface 110 and lower surface 112 disposed approximately parallel to one another. The present disclosure is not limited to this configuration. For example, the upper and lower surfaces 110, 112 may be non-parallel; e.g., the lower surface 112 may be disposed at an angle (e.g., about 10 degrees) relative to the upper surface 110, such that the distance between the upper and lower surfaces 110, 112 (i.e., the thickness) at the outer edge 108 is less than the distance between the upper and lower surfaces 110, 112 proximate the cassette surface from which the latch feature 104, 106 extends outwardly. In some embodiments, upper and lower surfaces 110 and 112 are represented by angles “φ” and “θ”. Angles φ and θ may be similarly or complementarily angled, may be similarly angled to angles α and/or β, and/or similarly or complementarily angled/shaped as catch surfaces 78 and/or 92.

Angle φ is generally between 0 and 90 degrees. In some embodiments, Angle φ is between about 5 and 85 degrees, and more preferably between about 10 degrees and about 60 degrees, such that it is neither parallel nor perpendicular with the x-y plane and thus engages a cassette latch mechanism(s) 106 more easily. Angle θ is generally between 0 and 90 degrees. In some embodiments, Angle θ is between about 5 and 85 degrees, and more preferably between about 10 degrees and about 60 degrees, such that it is neither parallel nor perpendicular with the x-y plane and thus engages a cassette latch mechanism(s) 106 more easily. In some embodiments, angles φ and θ are similar. In other embodiments, angles φ and θ are not equal.

In addition, all of the latch members 104, 106 may have the same geometric configuration, or different latch members 104, 106 may have different geometric configurations; e.g., to facilitate insertion of the cassette 44 into the cassette seat 36, and/or removal of the cassette 44 from the cassette seat 36. Upper surface 110 and lower surface 112 can be adjacent and or separated by a generally plateaued surface 105, a gap 107 and/or other physical means. The latch feature 104, 106 shown in FIG. 12 is provided as an exemplary embodiment of a front latch feature 104 or a back latch feature 106, or a latch feature that can be used for either. The present disclosure is not limited thereto.

In the operation of the cassette interface 34 embodiments described above, in a first instance wherein a cassette 44 is not disposed within the cassette seat 36 of the cassette interface 34 (e.g., see FIGS. 3, 4, and 9), the button 56 and front latch mechanism 38 are normally biased in an engaged position. In the engaged position, the head portion 64 of the front latch mechanism(s) 38 and the head portion 82 of the aft latch mechanism(s) 40 extend into the void defined by the cassette seat 36 of the cassette interface 34. In the engaged position, the user contact end 68 of the button 56 is disposed so that it is possible for a user to depress the button 56 (i.e. the button is in an unbiased, uncompressed, or rest state).

To insert a cassette 44 into the cassette seat 36 of some embodiments of the cassette interface 34 (and thereby load a cassette 44 into the waste disposal device 20), the user may generally vertically, linearly translate a cassette 44 into the cassette seat 36. As the cassette 44 is generally linearly translated into the cassette seat 36, the front latch feature 104 will contact the head portion ramp surface 72 of the front latch member 52 and the aft latch feature 106 will contact the head portion ramp surface 86 of the aft latch member 80. Further translation of the cassette 44 into the cassette seat 36 will cause the front latch member(s) 52 and the aft latch member(s) 80 to deflect outwardly. By generally linearly translate, it is meant that the cassette 44 may be other than in a parallel orientation with respect to the cassette seat 36 (and if the cassette seat 36 is other than a flat surface, the general plane defined by the cassette seat 36), but that the cassette 44 will eventually even-out upon engaging and deflecting the latch mechanism(s). In addition for those embodiments that include a cassette biasing mechanism 42, at some point in the translation of the cassette 44 into the cassette seat 36, the cassette 44 will engage the cassette biasing mechanism 42 and begin to depress the cassette biasing mechanism 42 from its normal position. As the front latch member 52 is deflected outwardly, the front latch member 52 pivots about its axis 66, which pivotal rotation is resisted by the spring 58. As the aft latch member 80 is deflected outwardly, the cantilevered stem 84 deflects outwardly (i.e. elastically). Once the front and aft latch features 104, 106 attached to the cassette 44 are translated beyond the respective ramp surface 72, 86, the biased front and aft latch members 52, 80 will return (i.e. elastically) to the engaged position within the cassette seat 36. The head portion catch surface 78, 92 of the respective front and aft latch members 52, 80 (now vertically aligned with the respective front and aft latch features 104, 106 of the cassette 44) will subsequently restrain the cassette 44 from being removed from the cassette interface 34 (e.g., see FIGS. 5, 6, and 8) and thereby assist in maintaining the cassette 44 in the cassette interface 34. The above described latch mechanism 38, 40 configurations may provide a tactile signal as the user feels the cassette 44 become secured in the waste disposal device 20. The above described latch mechanism 38, 40 configurations may provide an audible signal as the cassette 44 is loaded into the cassette seat 36. Alternatively, the above described configurations may be modified to include structure that will provide an audible signal. In those embodiments that include a cassette biasing mechanism 42, the cassette biasing mechanism 42 will bias the cassette 44 vertically upwardly to typically produce positive engagement between the respective cassette latch feature upper surface 110 and respective latch member head portion catch surface 78, 92. For further audible feedback, a fin 109 can be disposed proximal any latch feature(s) 104, 106 (either on the cassette or on the waste disposal device), such that a stronger audible signal and/or two audible signals are heard in close succession.

To remove a cassette 44 from the cassette seat 36 of the cassette interface 34 (and thereby remove a cassette 44 from the waste disposal device 20), the user contacts the user contact end 68 of the front latch mechanism button 56 and translates it (e.g., depresses it). Translation of the button 56 causes the spring 58 to elastically deform. As indicated above, the button latch member contact element 70 is engaged with the second leg 62 of the latch member 52 (e.g., to allow relative pivotal movement). As the button 56 is translated, the button 56 causes the substantially L-shaped latch member 52 to rotate about its pivot axis 66. The rotation of the L-shaped latch member 52 causes the head portion 82 attached to the first leg 60 of the latch member 52 to rotate out of the cassette seat 36 of the cassette interface 34. As a result, the latch member head portion 82 disengages with the cassette front latch feature 104 and the head portion 82 no longer maintains the cassette 44 within the cassette seat 36. In those embodiments that include a cassette biasing mechanism 42, once the cassette 44 is no longer restrained, the cassette biasing mechanism 42 will bias the cassette 44 vertically upwardly to facilitate removal of the cassette 44 from the cassette interface 34. In some embodiments, the head portion 82 of the aft latch mechanism(s) 40 may remain in its engaged position after the front latch mechanism 38 is disengaged. To remove the cassette 44, the cassette 44 may be rotated slightly to avoid such engagement and the cassette 44 can thereafter be removed.

For simplicity and general reference, the cassette 44 is defined to have a forward end region 63 that generally aligns/engages with aft wall portion 48 of the cassette interface 34. Similarly, the cassette 44 is defined to have an aft region 65 that generally aligns/engages with front wall portion 46 of the cassette interface. Other terms used throughout the present disclosure used to describe the cassette 44 and cassette interface 34 can be understood by virtue of the figures and description, and these general references.

The cassette biasing mechanism(s) 42 are positioned in the cassette interface 34 such that upon disengagement of the latch mechanism(s), at least a portion of cassette 44 is positioned such that it can be more easily removed from the waste disposal device 20. In some embodiments, the cassette biasing mechanism(s) 42 is(are) positioned towards the forward region 63 of the cassette 44 (as it would align when engaged with the aft wall portion 48 of the cassette interface 34) such that upon releasing the latch mechanism(s), the cassette 44 tips upward such that its forward region 63 is vertically upward (i.e. positioned higher) with respect to is aft region 65. In such an embodiment, the forward region 63 is thus easier to grasp as the cassette 44 is positioned skew from the cassette interface 34 thereby lengthening the distance of the cassette 44 outer perimeter 45 and/or inner perimeter 47 from the front wall portion 46, aft wall portion 48, inner wall portion 41, and/or base wall portion 50 of the cassette interface 34.

In other embodiments, the biasing mechanism(s) 42 is(are) positioned towards the aft region 65 of the cassette 44 (as it would align when engaged with the front wall portion 46 of the cassette interface 34) such that upon releasing the latch mechanism(s), the cassette 44 tips upward such that its aft region 65 is vertically upward (i.e. positioned higher) with respect to its forward region 63. In such an embodiment, the aft region 65 proximal the forward wall portion 24 of the waste disposal system 20 is easier to grasp with a shorter reach (as the user is likely to stand in front of the waste disposal device). In yet other embodiments, the biasing mechanism 42 is(are) positioned on a side region 67 and/or 69, and that said is duly positioned higher than the other side portion (i.e. 69 and/or 67, the side that does not have the biasing mechanism(s) 42). In such embodiments, this could be advantageous for consumers who stand proximal to a side wall portion 28 of the waste disposal device 20.

The above described front and aft latch mechanisms 38, 40 are provided as examples of the present disclosure, and the present disclosure should not be construed as being limited to these specific examples. For example, the front and aft latch mechanisms 38, 40 are each described above as having a head portion 64, 82 with an exposed ramp surface 72, 86 (disposed at an angle relative to vertical) and a catch surface 78, 92 (disposed in a substantially horizontal direction or as otherwise taught in the present disclosure). In an alternative embodiment as shown in FIG. 13, at least one of the front or aft latch(s) (both generically shown as 1352), or both, may include a latch member head portion 1364 having opposing ramp surfaces 1365, 1366; e.g., a triangular profile, a semi-circular profile, etc. In FIG. 13, the curved arrow 1367 indicates the rotating movement of the latch member 1352, and the straight arrow 1368 indicates the force direction that may be applied by the actuating the button 56 to move the latch member 1352 between engaged and disengaged positions.

Now referring to FIG. 14, as another example, the features of a latch member and a cassette latch feature may be switched so that features described above as being present in the latch member are now present in the latch feature, and vice versa. For example, the cassette 1444 may include a ramp structure 1472 and the latch member 1452 may include a feature that mates with the ramp structure 1472 affixed to the cassette 1444; e.g., a latch member 1452 having a head portion 1464 configured similar to the latch member shown in FIG. 12. Head portion 1464 is rounded as shown in FIG. 14, or has at least one facet in other embodiments. In some of these other embodiments, head portion 1464 has two facets defining surfaces. In some embodiments, such are similar to the ramp surfaces 1365 and 1366 in FIG. 13.

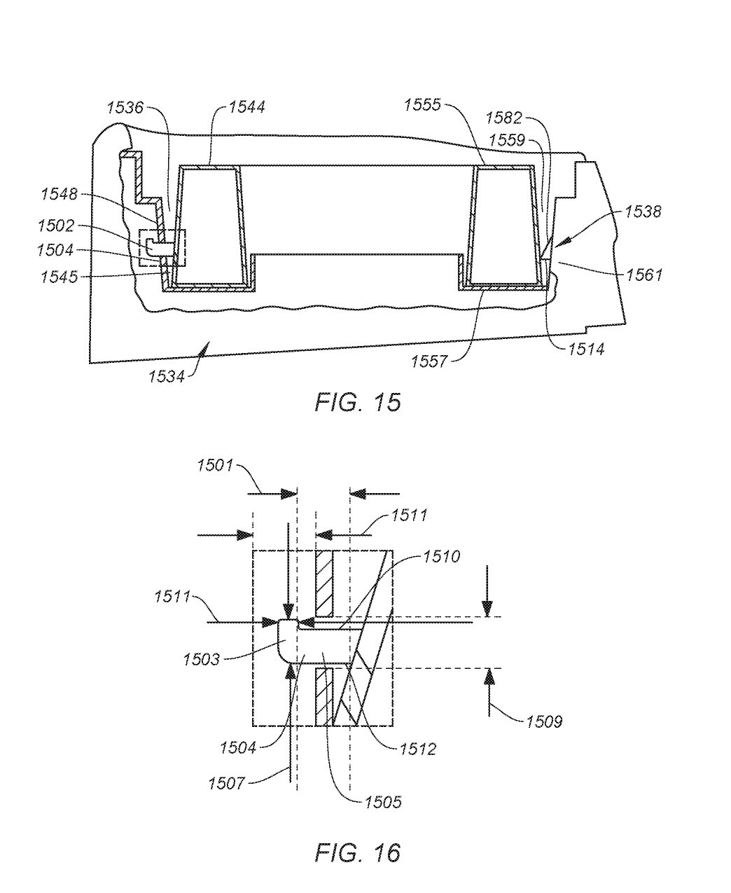

Referring to FIG. 15, in alternative embodiments the cassette interface 1534 may be configured to receive a cassette 1544 having at least one flange 1502 extending out from a rear surface that is received within a mating aperture 1504 in the aft wall portion 1548 of the cassette seat 1536. Flange 1502 has an upper surface 1510 and a lower surface 1512. The cassette 1544 is inserted into the cassette seat 1536 with the aft portion of the cassette 1544 entering the cassette seat 1536 first. The flange(s) 1502 are inserted into the aperture(s) 1504, and the forward portion of the cassette 1544 is rotated further into the cassette seat 1536. As the cassette 1544 rotates, a forward latch mechanism 1538 is engaged. The cassette 44 rotates between 0 and 90 degrees, depending on the configuration and geometry of the at least one flange 1502, the aperture 1504, as well as the underlying construction of the cassette 44 and cassette interface 34. In these embodiments, if a cassette biasing mechanism is included, it may operate as described above. Once the cassette 1544 is fully inserted into the cassette seat 1536, the forward latch mechanism 1538 maintains the cassette 1544 within the cassette seat 1536 of the cassette interface 1534. FIG. 15 shows a forward latch mechanism 1538 similar to that shown in FIGS. 6, 8, and 9; e.g., the head portion 1582 of a latch member 1552 is engaged with a latch feature 1514 extending outwardly from the cassette 1544. In some embodiments, upper surface 1510, head portion 1582 and/or lower surface 1512 are configured to have one or more a ramp surfaces. The alternative embodiments are not limited to any particular type of forward latch mechanism; e.g., any one of the front latch embodiments described above may be utilized.

In some embodiments, the flange 1502 is proximal the outer perimeter 1545. In some embodiments, the flange is proximal the bottom portion 1561 of the outer perimeter 1545. In other embodiments, the flange is proximal the upper portion 1559 of the outer perimeter 1545.

In yet other embodiments, the flange 1502 is an L shaped structure having a lower portion 1503 and an upper portion 1505. In these embodiments, the cassette latch mechanism connects to the first latch feature via rotation of the cassette about a forward portion of the outer perimeter 1545 of the cassette 1544. This rotation can be described as a “toe-in” movement/connection. The L shaped member is positioned such that the lower portion 1503 of the L points upward towards an upper surface 1555 of the cassette 1544. The L shaped member is positioned on the outer perimeter 45 of the cassette 1544 and in some embodiments, the outer wall 1545 of the cassette 1544. The L shaped member is positioned proximal the bottom surface 1557 of the cassette 1544. The cassette latch mechanism, in some embodiments, has two L shaped members. In these embodiments, the forward latch mechanism 1538 includes an aperture 1504 sized to receive at least the lower portion 1503 of the L shaped member. The aperture 1504 is sized such that the height 1509 of the aperture 1504 is less than the length 1507 of the lower portion 1503 of the L shaped member. In some embodiments, the length 1501 of upper portion 1505 is greater than the height of lower portion 1503. The depth 1511 of the aperture 1504 permits the L shaped member to rotate inside the aperture 1504 in order to achieve a state where the cassette 1544 is secured to the waste disposal device 20 and the lower portion 1503 of the L shaped member is at least partially internal to and secured within the aperture 1504. In some embodiments, the forward latch mechanism 1538 has two apertures 1504, where each aperture 1504 receives a different L shaped member. In further embodiments, the forward latch mechanism 1538 also assists with the at least partial ejection of the cassette 1544 from the waste disposal device 20.

In yet further embodiments, the flange 1504 has an upper surface 110 that is a first ramp surface and/or a lower surface 112 that is a second ramp surface, where the first ramp surface and/or second ramp surface are adjacent or are separated by a plateaued surface 105 or a gap 107.

The cassette 44 and/or latch mechanism provide a connection feature with a geometry that permits selective engagement of the cassette 44 to the cassette interface 34. As such, the cassette 44 is able to engage and disengage the cassette interface. To accomplish this, the cassette 44 and/or latch mechanism have such a connection feature with two features—one permitting engagement, and one permitting disengagement. These features can be on a single piece, or they can be discreet or separate pieces.

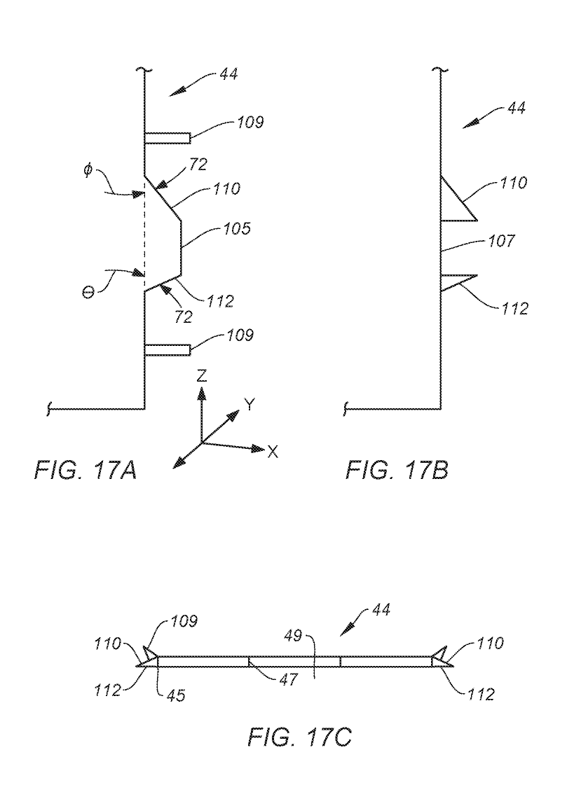

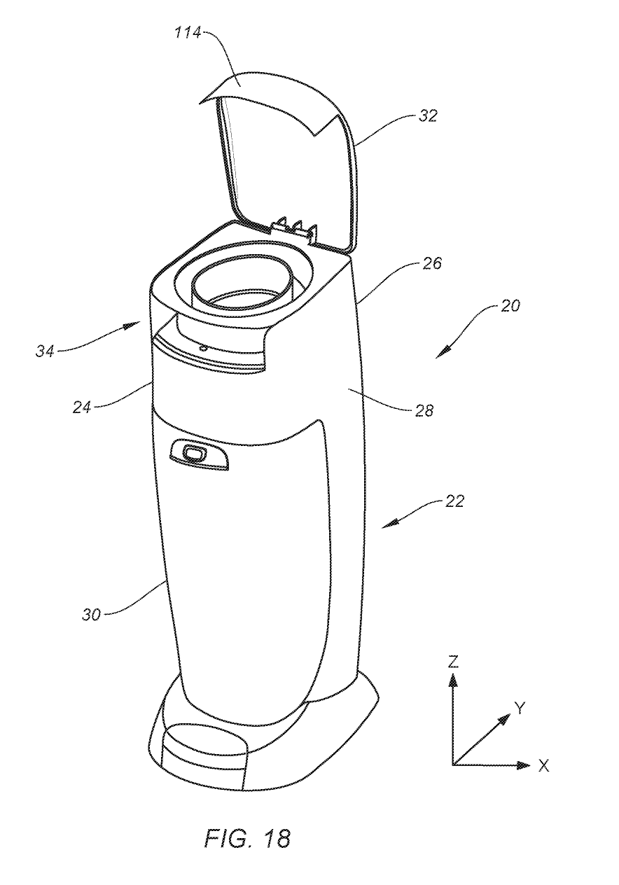

The cassette 44 and/or latch mechanism provide a connection feature with a geometry extending in two directions or in two distinct positions in a single plane, or at least two planes. By way of example, FIG. 7 demonstrates forward latch member having head portion 64 that includes ramp surface 72 sloping in generally the X-Y plane, and includes catch surface 78 sloping generally in the Y-X plane; FIGS. 12-14 and 17a-c show various features on cassette 44 or as part of the cassette interface 34 having two facets that are angled in different directions in the same plane and/or are generally parallel within the same plane; FIGS. 15-16 provide an L shaped member having lower portion 1503 extending generally in the Y-Z plane while upper portion 1505 extends general in the X-Y plane. Similar can be said about the embodiments in FIGS. 18-34, as discussed below.

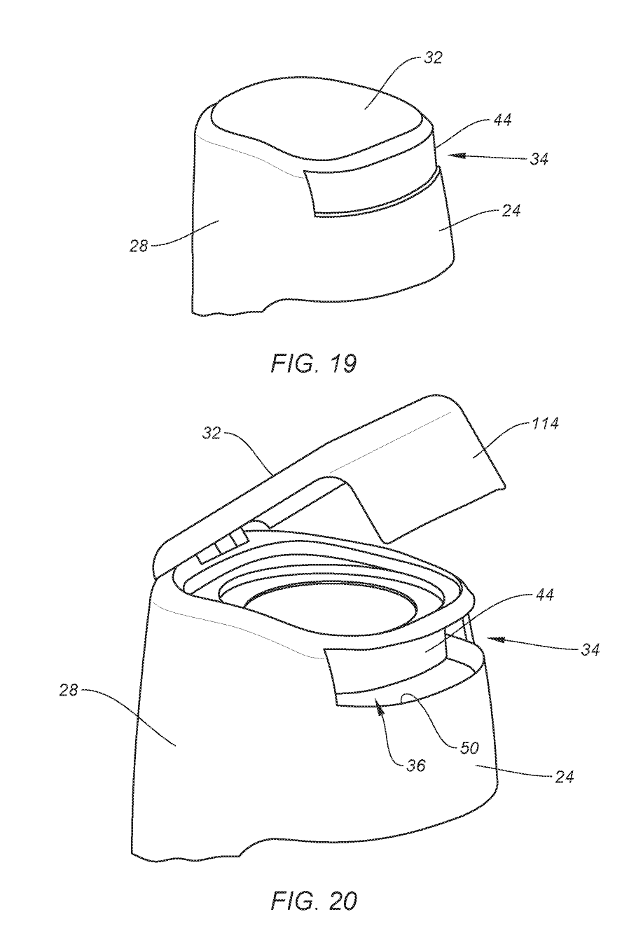

Now referring to FIGS. 18-34, other embodiments of the present disclosure may be implemented in front loading cassette configurations. FIG. 18, for example, shows a waste disposal device 20 with a cassette 44 that is inserted and removed in a direction (e.g., along the Y-axis) substantially perpendicular to the forward wall portion 24. In the embodiment shown in FIG. 18, the device lid 32 includes a forward portion 114 that conceals the front of the cassette 44 when the lid 32 is in the closed position. In some embodiments, lid 32 and forward portion 114 are shaped to have a less abrupt change in curvature. In other embodiments, lid 32 has other portions that extend radially outward similar to forward portion 114 to form a generally cylindrical looking shape. In the embodiment shown in FIG. 19, the lid 32 covers only a portion of the top of the device 20 and the front of the cassette 44 is exposed; e.g., the cassette 44 may have a forward portion configured to blend in with the forward wall portion 24 of the device 22.

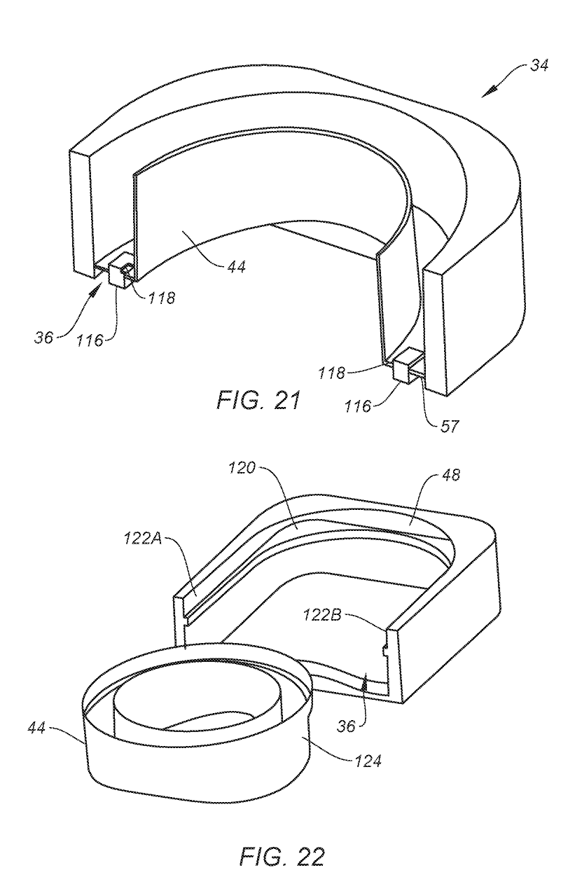

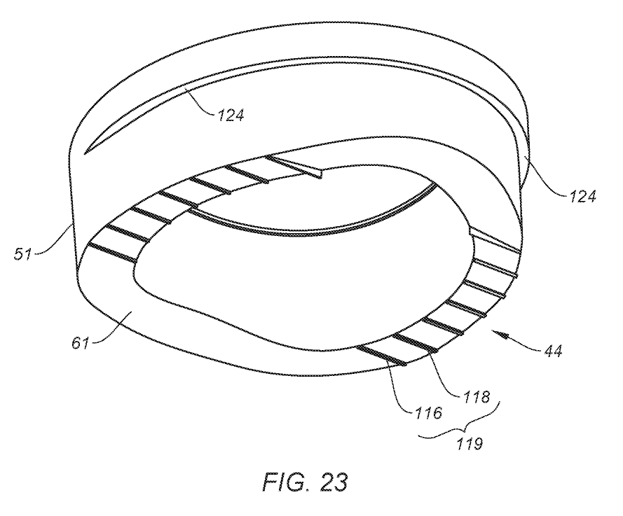

In some embodiments, the cassette 44 and the interface cassette seat 36 include mating features that guide the cassette 44 as it is inserted into and/or removed from the cassette seat 36, and may also support the cassette 44 when it is disposed within the cassette seat 36. For example as can be seen in FIG. 20, the cassette 44 may include one or more rails 116 extending out from the bottom portion 61 of the cassette 44, and in some embodiments from the bottom wall 57 of the cassette 44. In some embodiments, one or more rails optionally extend outward from the first side region 67 and/or second side region 69. At least one of the one or more rails 116 aligns with and is received into a mating channel 118 disposed in or on the base wall portion 50 of the cassette seat 36. The mating rail 116 and channel 118 configuration guides movement of the cassette 44 relative to the cassette seat 36 and may also support the cassette 44 relative to the cassette seat 36. In some embodiments, the positioning of the rails 116 and the channels 118 may be reversed. For example, FIG. 21 is a sectioned view that shows the cassette seat 36 having a pair of rails 116 that mate with channels 118 disposed in the lower surface 57 of a cassette 44. In some embodiments, the cassette seat 36 includes one or more shelves disposed on cassette seat side wall portions 122A, 122B, and may also include a shelf disposed in the cassette seat aft wall portion; e.g., the embodiment shown in FIG. 22 shows a shelf 120 example that extends from cassette seat one side wall portion 122A, across the aft wall portion 48, to the opposite cassette seat side wall portion 122B. In these embodiments, the cassette 44 includes at least one flange 124 that mates with the shelf 120; e.g., when the cassette 44 resides within the cassette seat 36, each flange 124 rests on a respective portion of the shelf 120. The bottom perspective view of a cassette 44 embodiment shown in FIG. 23 shows a flange 124 that extends along the side and aft portions of the cassette outer wall 51. Alternatively, or in combination, the cassette 44 and cassette seat 36 may have at least one mating rail 116 and channel 118 (e.g., similar to that described above) disposed in respective side walls of the cassette 44 and cassette interface 34 to guide and/or support the cassette 44 relative to the cassette seat 36. As shown in FIG. 23, some embodiments of cassette 44 include one or more rails 116 and channels 118. The combination of such can form a tread-like structure 119 on at least a portion of cassette 44, such as one or both side portions and/or the forward portion. The tread-like structure 119 has a reciprocal or mating structure having rails 116 and channels 118 on cassette seat 36.

Furthermore, in some embodiments, the upper surface 110 and/or a lid of the cassette 44 can be equipped with reciprocal features (rails 116, channels 118, tread 119) such that one cassette 44 is stackable on a second cassette 44. The structure of rails 116, channels 118 and/or tread 119 enables a mating engagement between cassettes 44 that is streamlined (i.e. the structures are low-profile) and also mitigates movement between the cassettes 44 about the y-axis and x-axis. In some embodiments, the rails 116, channels 118 and/or tread 119 is configured such that such structures extend to the outer perimeter of the cassette lid or upper surface 110.

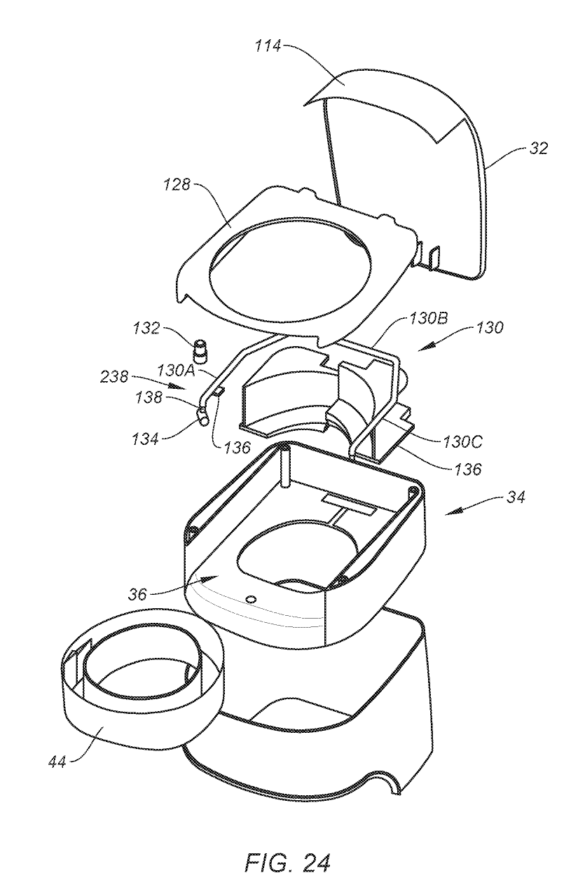

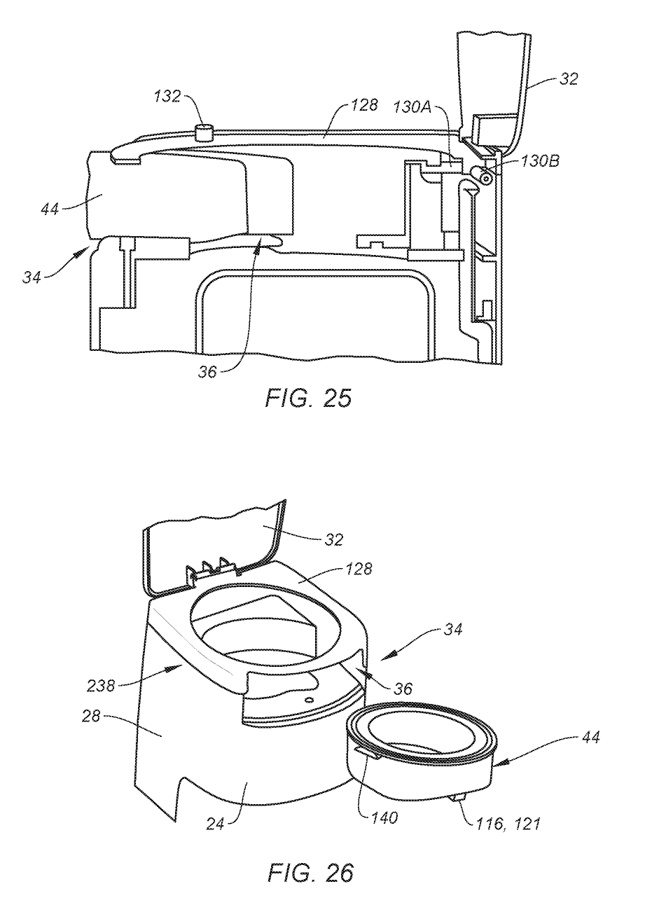

In some embodiments, the cassette interface 34 may include a latch mechanism 238 configured to retain the cassette 44 within the cassette seat 36 once inserted. A variety of different latch mechanisms 238 may be used to retain the cassette 44, and the present disclosure is not limited to any particular type of latch mechanism. FIG. 24 shows an exploded view of a cassette interface 34 embodiment having a top panel 128 and a latch mechanism 238 that includes a U-shaped latch bar 130, at least one button 132, and a latch bar biasing mechanism (e.g., spring 134). The U-shaped latch bar 130 includes a first side portion 130A, and aft portion 130B, and a second side portion 130C. Each side portion 130A, 130C includes a latch tab 136 extending outwardly from the respective side portion 130A, 130C and a biasing post 138. The sectional view shown in FIG. 25 shows the aft portion 130B of the U-shaped latch bar 130 pivotally retained towards the aft portion of the cassette seat 36. A biasing member 134 (e.g., a spring) acting between a fixed surface (e.g., within the cassette interface 34) and the respective side portion 130A, 130C of the U-shaped latch bar 130 biases the side portion 130A, 130C upwardly (e.g., clockwise rotation in the view shown in FIG. 25), thereby causing the aft portion 130B of the U-shaped latch bar 130 to act as a pivot axis. One or more biasing members 134 may be used to bias the first side portion 130A of the U-shaped latch bar 130 and/or one or more biasing members 134 may be used to bias the second side portion 130C of the U-shaped latch bar 130 in similar manner. Each button 132 (the embodiment shown in FIG. 24 shows a single button 132, but there may be more than one button) is configured to contact the respective side portion 130A, 130C of the U-shaped latch bar 130 (or indirectly contact via a tab, etc.). The biasing member(s) 134 therefore also biases the button 132 upwardly. Depressing the button(s) 132 causes the respective side portion 130A, 130C to move downwardly (e.g., rotate slightly), which downward motion is resisted by the at least one biasing member 134. As will be described below, sufficient movement of the side portions 130A, 130C of the U-shaped latch bar 130 downwardly causes the latch tab 136 extending outwardly from the respective side portion 130A, 130C to move (e.g., substantially vertically) from an engaged position to a disengaged position.

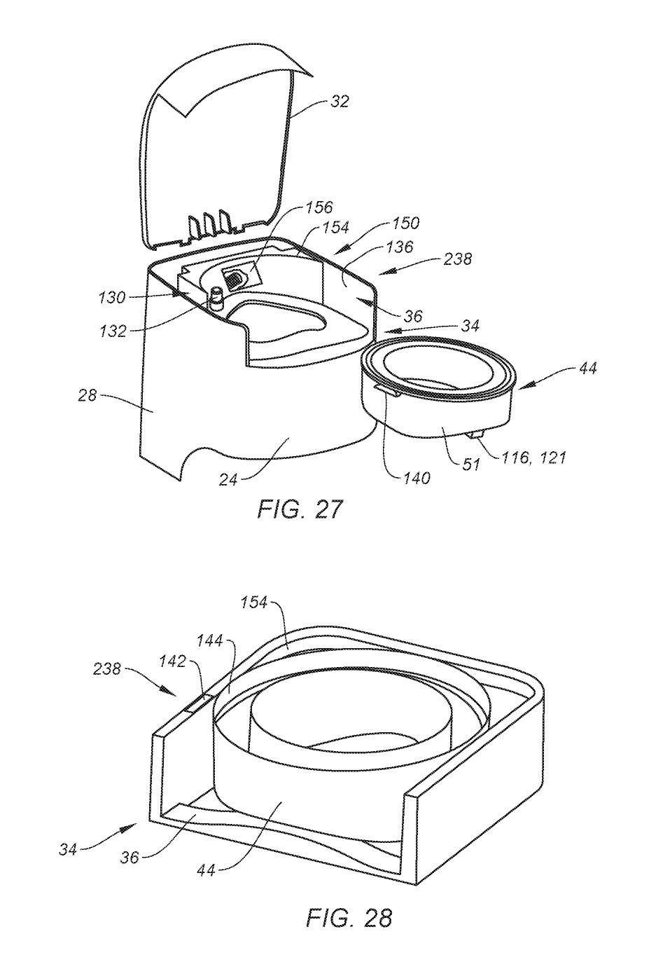

As can be seen in FIGS. 26 and 27, the cassette 44 includes a latch feature 140 extending out from (or disposed in) a side region of its outer wall 51 for each latch tab 136 of the U-shaped latch bar 130; e.g., in the embodiments shown in FIGS. 24-26, the U-shaped latch bar 130 includes opposing latch tabs 136 and the cassette 44 includes a mating latch feature 140 for each latch tab 136. The configuration of each latch feature 140 is such that when the cassette 44 is inserted into the cassette seat 36, the latch feature 140 pushes the latch tab 136 out of the way (e.g., downwardly to allow the latch feature 140 to move past the latch tab 136). Once the cassette 44 is inserted sufficiently into (or onto, or at least partially adjacent to) the cassette seat 36, the latch feature 140 is disposed beyond the latch tab 136 and the biasing member 134 forces the latch tab 136 back upwardly. As a result, the latch tab 136 is positioned to interfere with the feature 140 and thereby retain the cassette 44 within the cassette seat 36. The geometries of the latch tab 136 and the cassette latch feature 140 are mating, but are not limited to any mating configuration. Examples of mating configurations are described above in terms of a latch member head portion 64 and a latch feature 140. The mating configurations of latch member head portion 64 and latch feature 104 are non-limiting examples of configurations that may be utilized with the latch tabs 136 and the latch features 140 in these front loading cassette 44 embodiments.

Latch feature 140 is generally L-shaped such that a portion of the “L” acts as a stop surface when engaged by latch tab 136. In the embodiments shown in FIGS. 26-27, the L shape describes at least one of the protruding portion of latch feature 140 and/or the recessed portion of latch feature 140. Latch feature 140 optionally has a first ramp surface and/or a second ramp surface, to assist with insertion, connection and/or at least partial ejection of the cassette 44 from waste disposal device 20.

FIGS. 26 and 27 show non-limiting examples of a cassette interface 36 and cassette 44 having a special rail 116 and channel 118 system. Cassette 44 has rail 116 on the aft portion of the cassette, such that rail 116 extends from the bottom portion 61, or furthermore at least one or both of the bottom surface 57 and/or aft region 65. The rail 116 acts as a rudder 121 and helps assist the cassette 44 during the loading process to ensure the cassette 44 is properly aligned with cassette interface 34. Rudder 121 can have a variety of shapes and configurations, and can include a first ramp surface and/or a second ramp surface (either/both as discussed throughout the present disclosure in other exemplary embodiments), and/or other configurations that are matingly received in a reciprocal feature in the cassette interface (perhaps on cassette seat 36).

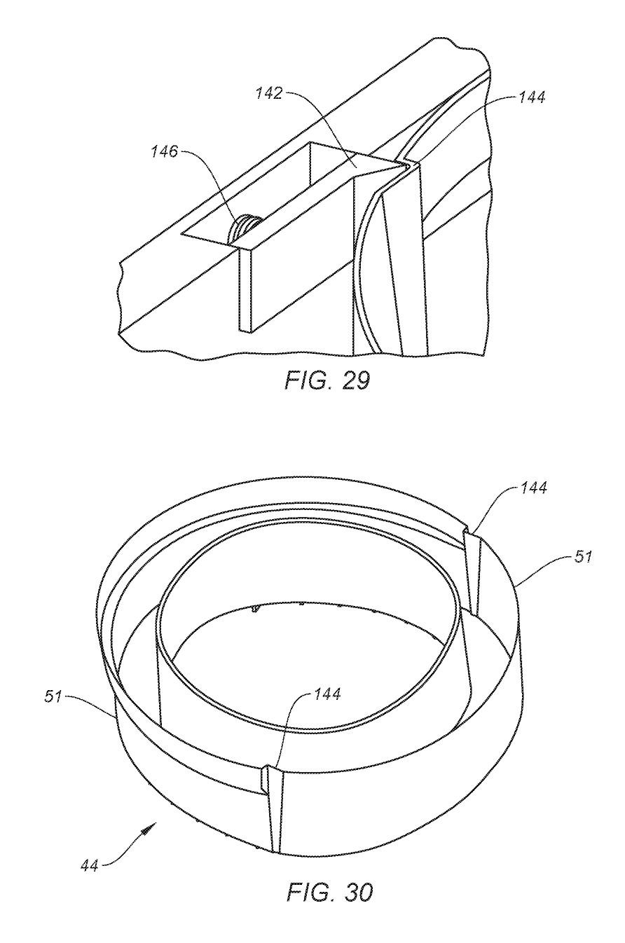

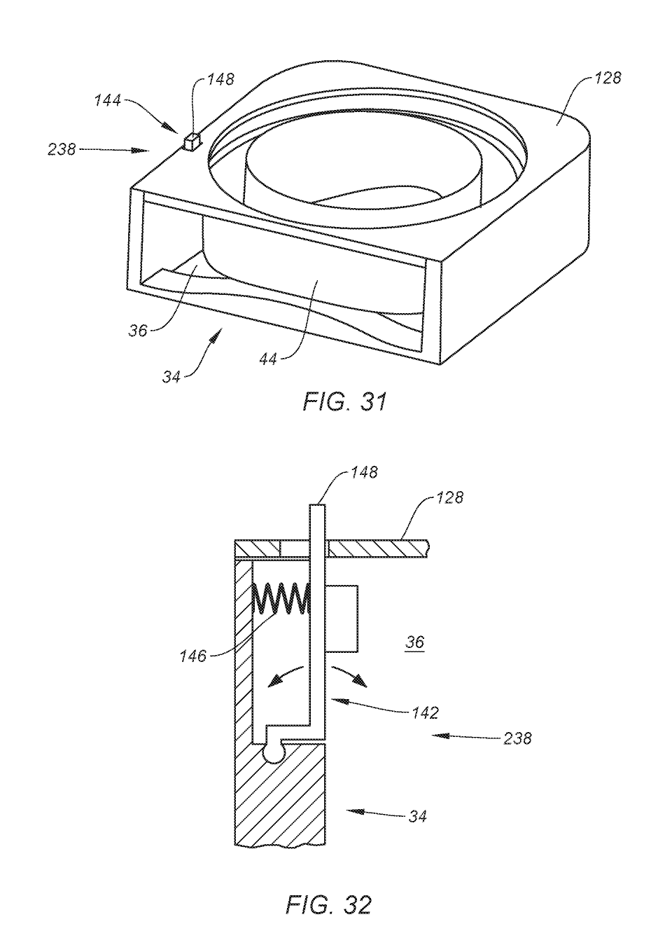

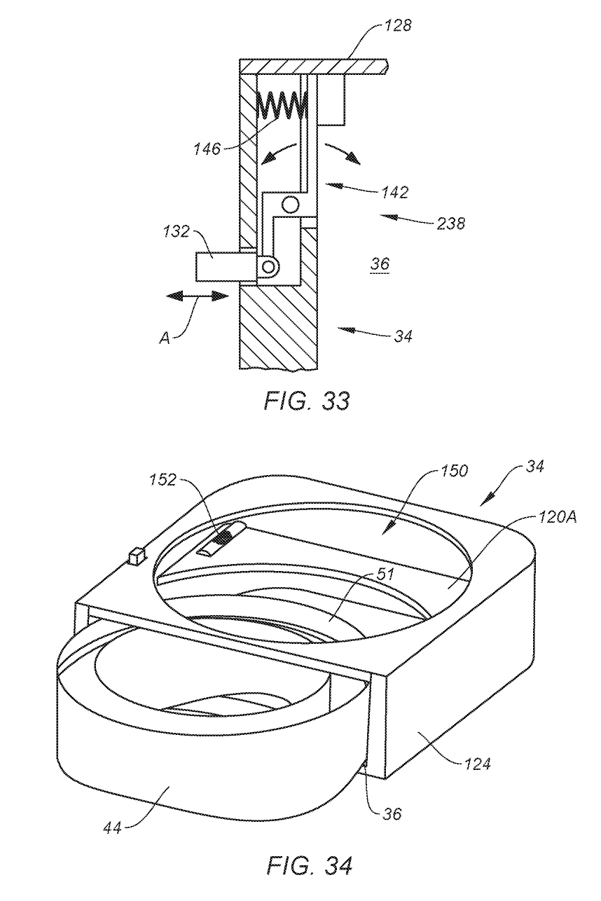

Other non-limiting examples of a latch mechanism 238 can be seen in FIGS. 28-31. In these embodiments, the latch mechanism 238 includes a latch tab 142 that is moved laterally relative to the cassette 44 to engage or disengage with a latch feature 144 disposed in or on the side region of the cassette outer wall 51. FIG. 28, for example, shows a diagrammatic depiction of a cassette 44 retained within a cassette seat 36 by a laterally movable latch tab 142. FIG. 29 is an enlarged view of the diagrammatically shown latch tab 142 shown in FIG. 28. The latch tab 142 is biased (e.g., by a spring 146) towards the center of the cassette seat 36, into engagement with the latch feature 144 of the cassette 44. FIG. 30 illustrates an example of a latch feature 144 disposed relative to the outer wall 51 of the cassette 44. FIGS. 31 and 32 diagrammatically show a latch mechanism 238 embodiment with a latch tab 142 having an arm 148 that extends outwardly above a top panel 128 of the cassette interface 34. The latch tab 142 is pivotally attached to the cassette interface 34. In the normal cassette engaged position (shown in FIG. 32, the latch tab 142 (and attached arm 148) are biased laterally towards an inner region of the cassette seat 36. Sufficient movement of the attached arm 148 laterally outwardly causes the latch tab 142 to move from the engaged position to a disengaged position, wherein the cassette 44 is no longer retained by the latch tab 142. FIG. 33 diagrammatically shows another latch mechanism 238 embodiment having a button 132 extending out from a side wall portion of the cassette interface 34. A biasing mechanism (e.g., a spring 146) normally biases the latch tab 142 in an engaged position. Sufficient movement of the button 132 (e.g., depressing the button in the direction of line “A”) causes the latch tab 142 to rotate from the engaged position to a disengaged position, wherein the cassette 44 is no longer retained by the latch tab 142.

Embodiments having top panel 128 provide certain advantages, namely the ability to load a cassette 44 into housing 22 with a single hand, and thereafter, dispense (i.e. pull) film upward from the cassette 44 while the cassette 44 is retained in the waste disposal device 20, thereby avoiding the need for two hand use during this interaction with the waste disposal device 20. Top panel 128, in some embodiments, can assist in metering film dispensed from cassette 44. Further still, top panel 128 can cooperate with certain cassette(s) 44 that do not have an upper surface 110 or cassette lid feature, or have a removable surface (i.e., shrink-wrap or overwrap) and thus need another means for containing and/or dispensing film from the cassette 44. Said differently, top panel 128 can act as an upper surface 110 and/or cassette lid. In some embodiments, top panel 128 can have a unique shape such that it functions similar to a funnel and helps direct waste into film (and thus the storage portion of the waste disposal device 22).

The latch mechanism 238 embodiments described above are merely examples of latch mechanisms and the present disclosure is not limited thereto; e.g., the latch mechanism could be operated by a button extending out of the top panel 128 of the cassette interface 34. In addition, as indicated above, the geometries of the latch tab 142 and the cassette latch feature 144 are mating, but are not limited to any mating configuration. Examples of mating configurations are described above in terms of a latch member head portion 64 and a latch feature 104. The mating configurations of latch member head portion 64 and latch feature 104 are non-limiting examples of configurations that may be utilized with the latch tabs 142 and the latch features 144 in these front loading cassette embodiments.

In some embodiments as exemplified in FIGS. 28-30, latch features 144 are generally L-shaped such that a portion of the “L” acts as a stop surface when engaged by latch tab 142. In the embodiments shown in FIGS. 26-27, the L shape describes the recessed portion of latch feature 144 and/or latch tab 142. Latch feature 144 and/or latch tab 142 optionally have a first ramp surface and/or a second ramp surface, to assist with insertion, connection and/or at least partial ejection of the cassette 44 from waste disposal device 20. In embodiments where both latch feature 144 and latch tab 142 have at least one ramp surface, the ramp surfaces may be complimentary and/or similarly angled and/or similar to any other described ramp angle discussed throughout the present disclosure.

In some embodiments, the cassette interface 34 may include a cassette biasing mechanism 150 disposed in or as part of the cassette seat 36 of the cassette interface 34. The cassette biasing mechanism 150 biases the cassette 44 outwardly in the direction toward the forward wall portion 24 of the waste disposal device 20 (e.g., see FIG. 18). For example, as a cassette 44 is inserted (in a generally horizontal direction when the waste disposal device 20 is in its normal operation position) into the cassette seat 36, the cassette biasing mechanism 150 will begin (at some point in the inward travel) resisting the insertion movement of the cassette 44. If the cassette 44 is inserted far enough into the cassette seat 36, the latch mechanism 238 (as described above) will begin to transition from an engaged position to a disengaged position to allow entry of the cassette 44. After sufficient inward movement of the cassette 44 into the cassette seat 36, the latch mechanism 238 will begin to transition from a disengaged position to an engaged position and thereafter be in a position to retain the cassette 44 within the cassette seat 36. When the cassette 44 is retained within the cassette seat 36, the cassette biasing mechanism 150 may bias the cassette 44 so that the cassette latch feature 144 is positively engaged with the respective latch tab 142.

An example of a cassette biasing mechanism 150 for a waste disposal device 20 having a front loading cassette is shown in FIG. 34. In this embodiment, the cassette biasing mechanism 150 includes a shelf portion 120A configured to receive a cassette 44 having flanges 124 that mate with the shelf 120A (e.g., see FIGS. 22 and 23 for an example of a flange 124 and shelf 120 arrangement). The shelf portion 120A is biased (e.g., by springs 152) toward the forward wall portion 24 of the waste disposal device 20 (i.e., towards a forward portion of the cassette interface 34). As the cassette 44 in inserted into the cassette seat 36, the flanges 124 disposed around at least a portion of the cassette 44 begin to mate with the shelf portion 120A, the outer wall 51 of the cassette 44 engages the shelf portion 120A. Further inward movement of the cassette 44 into the cassette seat 36 causes the shelf portion 120A to move inwardly with the cassette 44. The shelf portion biasing means (e.g., springs 152) resists but allows the cassette 44 to move towards at least a portion of the shelf (i.e. 120A, 120B, and/or any portion therebetween) and/or movement by the shelf (i.e. 120A, 120B and/or any portion there between), and in broader terms, permits engagement of the cassette 44 and the cassette interface 34. As indicated above, once the cassette 44 is inserted far enough into the cassette seat 36, the latch mechanism 238 will transition to an engaged position and thereafter retain the cassette 44 within the cassette seat 36 and the cassette biasing mechanism 150 will bias the cassette 44 so that the cassette latch feature 144 is positively engaged with the latch tab 142.

Another example of a cassette biasing mechanism 150 for a waste disposal device 20 having a front loading cassette is shown in FIG. 27. In this embodiment, the cassette seat 36 is partially defined by an aft wall portion 154 that is forwardly biased and configured to receive a cassette 44. The aft wall portion 154 is biased (e.g., by springs 156) toward the forward wall portion 24 of the waste disposal device 20 (i.e., towards a forward portion of the cassette interface 34). As the cassette 44 in inserted into the cassette seat 36, the outer wall 51 of the cassette 44 engages the aft wall portion 154. Further inward movement of the cassette 44 into the cassette seat 36 causes the aft wall portion 154 to move inwardly with the cassette 44. The aft wall portion 154 biasing means (e.g., springs 156) resists but allows the cassette 44 to move towards at least a portion of the shelf (i.e. 120A, 120B and/or any portion there between) and/or movement by the aft wall portion 154, and in broader terms, permits engagement of the cassette 44 and the cassette interface 34. As indicated above, once the cassette 44 is inserted far enough into the cassette seat 36, the latch mechanism 238 will transition to an engaged position and thereafter retain the cassette 44 within the cassette seat 36 and the cassette biasing mechanism 150 will bias the cassette 44 so that the cassette latch feature 140, 144 is positively engaged with the latch tab 136, 142.

In any of the above cassette biasing mechanism 150 embodiments for a device 20 with a front loading cassette 44, when the cassette 44 is to be replaced, the latch mechanism 238 is actuated, thereby causing the latch tab 136,142 to disengage with the cassette latch feature 140,144. Once the latch mechanism 238 is disengaged, the cassette biasing mechanism 150 will cause the cassette 44 to at least partially eject from the cassette seat 36. As a result, replacement of the cassette from the device 20 is greatly facilitated.

In this document, the terms “a” or “an” are used, as is common in patent documents, to include one or more than one. In this document, the term “or” is used to refer to a nonexclusive or, unless otherwise indicated. It is to be understood that the above description is intended to be illustrative, and not restrictive. For example the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc., as they may be included, are used merely as labels, and are not intended to impose numerical requirements on their objects. In the Detailed Description provided above, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A waste disposal device cassette interface, comprising:
a cassette seat having at least one wall portion and configured to receive at least a portion of a liner cassette; and
a latch mechanism configured to retain the cassette within the cassette seat.

2. The interface of claim 1, the latch mechanism comprising a latch member and a latch biasing mechanism, which latch biasing mechanism is configured to normally bias the latch member in an engaged position.

3. The interface of claim 2, wherein the latch biasing mechanism includes a button in communication with the latch member, which button is normally disposed in a first position and is selectively translatable to a second position.

4. A waste disposal device cassette interface, comprising:
a cassette seat configured to receive at least a portion of a liner cassette;
at least one forward latch mechanism selectively configurable in an engaged position and a disengaged position, wherein in the engaged position the forward latch mechanism is positioned to retain the cassette within the cassette seat;
at least one aft latch mechanism normally biased in an engaged position, wherein in the engaged position the aft latch mechanism is positioned to retain the cassette within the cassette seat.

5. The interface of claim 4, further comprising a cassette biasing mechanism configured to bias the liner cassette vertically upward relative to the cassette seat.

6. A cassette for the disposal of waste, comprising:
a length of liner film for holding waste; and
a cassette body having an outer perimeter and an inner perimeter defining a central opening through which said liner film is passed, the cassette body having at least one latch feature positioned on said outer perimeter, said latch feature having an upper surface and a lower surface, wherein at least one of said upper surface and said lower surface is a first ramp surface.

7. The cassette according to claim 6, wherein said latch mechanism comprises a second ramp surface.

8. The cassette according to claim 6, wherein said latch mechanism further comprises a head portion, wherein said head portion extends from said upper surface of said latch mechanism and has said first ramp surface.

9. The cassette according to claim 8, wherein said latch mechanism is generally L shaped.

10. The cassette according to claim 7, wherein said first ramp surface and said second ramp surface are adjacent.

11. The cassette according to claim 10, wherein said first ramp surface and said second ramp surface have different angles.

12. The cassette according to claim 11, wherein said first ramp surface has an angle of between about 5 degrees and about 85 five degrees.

13. The cassette according to claim 11, wherein said second ramp surface has an angle of between about 5 degrees and about 90 degrees.

14. The cassette according to claim 7, wherein said first ramp surface and said second ramp surface are separate from each other, separated by a plateaued surface, a gap, or a combination thereof.

15. The cassette according to claim 6, wherein said latch feature comprises at least two latch features, wherein said latch features are asymmetrically located about the outer perimeter of said cassette with respect to at least one axis.

16. The cassette according to claim 6, wherein said latch feature comprises at least two latch features, wherein said latch features are symmetrically located about the outer perimeter of said cassette with respect to at least one axis.

17. The cassette according to claim 6, wherein said cassette further comprises a fin proximal to said latch feature.
